(19) United States
(12) Patent Application Publication
(10) Pub. No.: US 2020/0042009 A1
(43) Pub. Date: Feb. 6, 2020

(54) UNMANNED LAWN MOWER WITH AUTONOMOUS DRIVING

(71) Applicant: LINGDONG TECHNOLOGY(BEIJING)CO.LTD, Beijing (CN)

(72) Inventors: Liye YANG, Beijing (CN); CHIUNGLIN CHEN, Beijing (CN)

(21) Appl. No.: 16/472,901

(22) PCT Filed: Jun. 20, 2018
(86) PCT No.: PCT/CN2018/091941

§ 371 Date: Jun. 24, 2019

(51) Int. Cl. G05D 1/02; A01D 34/00; G05D 1/00; A01D 34/84

(52) U.S. Cl. CPC G05D 1/0246; A01D 34/008; G05D 1/0212; A01D 2101/00; A01D 34/84; G05D 2201/0208; G05D 1/0088

(57) ABSTRACT

An unmanned lawn mower includes a mower body, a cutting module, a wheel module, a camera module and a CPU. The cutting module is mounted on the mower body and configured to weed. The wheel module is mounted on the mower body and configured to move the mower body. The camera module is mounted on the mower body and configured to capture images of surroundings of the mower body. The CPU is coupled to the cutting module, the wheel module and the camera module. The central processing unit controls the cutting module and the wheel module to weed within an area according to the images captured by the camera module and control signals from a handheld electronic device, or the central processing unit controls the cutting module and the wheel module to weed within the area according to the images captured by the camera module.

### BACKGROUND OF THE INVENTION

### 1. Field of the Invention

The present invention relates to a lawn mower, and more particularly, to an unmanned lawn mower with autonomous driving.

### 2. Description of the Prior Art

Generally speaking, a conventional lawn mower needs a perimeter wire to be placed on the grass, defining a boundary for assisting the lawn mower to weed within a region defined by the perimeter wire. Also, a user needs to preset the perimeter wire prior to activate the lawn mower in order for proper functioning of the lawn mower. As a result, it leads to neither convenience of use nor being artificially intelligent for the lawn mower.

### SUMMARY OF THE INVENTION

The present invention provides an unmanned lawn mower with autonomous driving for solving above drawbacks.

For the abovementioned purpose, the unmanned lawn mower with autonomous driving is disclosed and includes a mower body, a cutting module, a wheel module, a camera module and a central processing unit (CPU). The cutting module is mounted on the mower body and configured to weed. The wheel module is mounted on the mower body and configured to move the mower body. The camera module is mounted on the mower body and configured to capture images of surroundings of the mower body. The CPU is mounted in the mower body and coupled to the cutting module, the wheel module and the camera module. The central processing unit controls the cutting module and the wheel module to weed within an area according to the images captured by the camera module and control signals from a handheld electronic device, or the central processing unit controls the cutting module and the wheel module to weed within the area according to the images captured by the camera module.

Preferably, a boundary within the area for weeding is defined by the control signals sent by the handheld electronic device cooperatively with the images captured by the camera module, and the unmanned lawnmower weeds within the boundary.

Preferably, the CPU defines a plurality of image characteristics on the boundary according to the images captured by the camera module.

Preferably, the camera module is a stereo camera, and each of the image characteristics comprises a depth message.

Preferably, the CPU computes a weeding trajectory within the boundary based on a profile of the boundary.

Preferably, a route within the area for weeding is defined by the control signals sent by the handheld electronic device cooperatively with the images captured by the camera module, and the unmanned lawn mower weeds along the route.

Preferably, the unmanned lawn mower further includes a wireless signal based positioning module coupled to the CPU and configured to position the mower body by establishing connection with at least one wireless positioning terminal. A boundary or a route is defined by the control signals sent by the handheld electronic device, the images captured by the camera module and wireless positioning signals transmitted from the at least one positioning terminal, and the unmanned lawn mower weeds within the boundary or along the route.

Preferably, the unmanned lawn mower further includes a dead reckoning module coupled to the CPU and configured to position the mower body. The boundary or the route is further defined by the dead reckoning module.

Preferably, the wireless signal based positioning module includes at least one of a GPS module, a WiFi signal receiving module and a Bluetooth signal receiving module, and the dead reckoning module includes a gyroscope and/or an accelerometer.

Preferably, the unmanned lawn mower further includes a proximity sensor module coupled to the CPU and configured to detect an object around the mower body. The proximity sensor module generates a proximity warning signal when the object is within a predetermined range relative to the mower body.

Preferably, the unmanned lawn mower further includes a remote device communication module coupled to the CPU and configured to establish connection with the handheld electronic device. The handheld electronic device operably sends the control signals to the remote device communication module, and the CPU controls the wheel module to move based on the control signals and the camera module to capture the images when the mower body is moved. The CPU controls the remote device communication module to transmit the images to the handheld electronic device.

In summary, the unmanned lawn mower of the present invention is equipped with the camera module to capture the image of the surroundings of the mower body, allowing the boundary or the route within the area for weeding to be defined by the images captured by the camera module through image processing. It not only leads to convenience of use for the unmanned lawnmower of the present invention, but also enables the unmanned lawn mower of the present invention to be more artificially intelligent.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram of an unmanned lawn mower according to an embodiment of the present invention.

FIG. 2 is a partially exploded diagram of the unmanned lawn mower according to the embodiment of the present invention.

FIG. 3 is a schematic diagram of a camera module and a driving mechanism in an expanded status according to the embodiment of the present invention.

FIG. 4 is a schematic diagram of the camera module and the driving mechanism in a retracted status according to the embodiment of the present invention.

FIG. 5 is a schematic diagram illustrating inner components of the unmanned lawn mower according to the embodiment of the present invention.

FIG. 6 is a functional block diagram of the unmanned lawn mower according to the embodiment of the present invention.

FIG. 7 is a flowchart of a method for defining a boundary for the unmanned lawnmower to weed according to the embodiment of the present invention.

FIG. 8 is a schematic diagram illustrating a scenario of the unmanned lawn mower weeding in a yard according to the embodiment of the present invention.

FIG. 9 is a top view of the scenario shown in FIG. 8 according to the embodiment of the present invention.

FIG. 10 is a schematic diagram illustrating a handheld electronic device with a user interface with respect to the unmanned lawn mower in a first position in FIG. 9.

FIG. 11 is a schematic diagram illustrating the handheld electronic device with the user interface with respect to the unmanned lawn mower in a second position in FIG. 9.

FIG. 12 is a flow chart of a method for defining a route for the unmanned lawn mower to weed according to another embodiment of the present invention.

FIG. 13 is a top view of the scenario shown in FIG. 8 according to another embodiment of the present invention.

FIG. 14 is a flow chart of a method for defining the boundary for the unmanned lawn mower to weed by following a movement of a user according to another embodiment of the present invention.

FIG. 15 is an identification image of the user and an image model of the user according to another embodiment of the present invention.

FIG. 16 is a top view of the scenario shown in FIG. 8 according to another embodiment of the present invention.

FIG. 17 is a flow chart of a method for obstacle avoidance and shutdown for living creature according to another embodiment of the present invention.

FIG. 18 is a schematic diagram illustrating the unmanned lawn mower performing obstacle avoidance according to the embodiment of the present invention.

FIG. 19 is a schematic diagram illustrating the unmanned lawn mower performing safety shutdown according to the embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

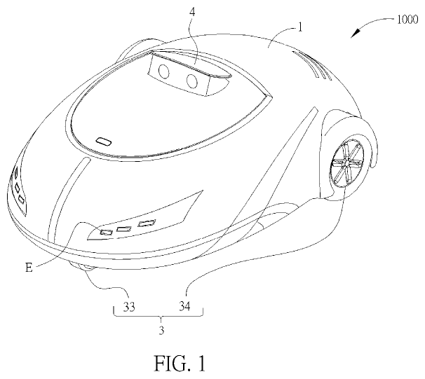

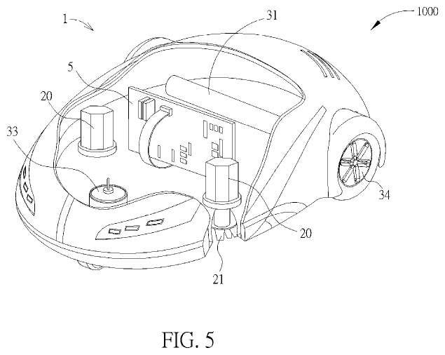

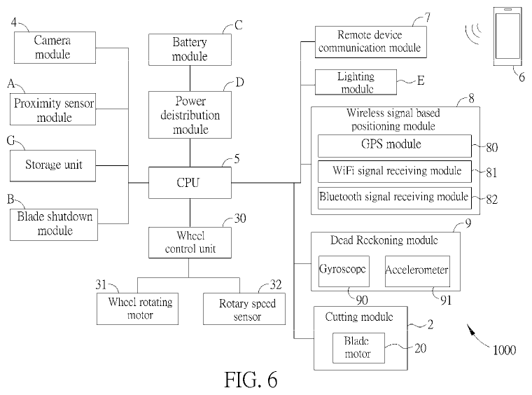

Referring in FIG. 1, FIG. 5 and FIG. 6, an unmanned lawn mower 1000 with autonomous driving is provided for weeding in an area, e.g., a yard of a house. The unmanned lawn mower 1000 includes a mower body 1, a cutting module 2, a wheel module 3, a camera module 4 and a central processing unit (CPU) 5. The cutting module 2 is mounted on the mower body 1 and configured to weed. The wheel module 3 is mounted on the mower body 1 and configured to move the mower body 1. The camera module 4 is mounted on the mower body 1 and configured to capture images of surroundings of the mower body 1. The CPU 5 is mounted in the mower body 1 and coupled to the cutting module 2, the wheel module 3 and the camera module 4.

In the present embodiment, the cutting module 2 can include a blade motor 20 and a blade unit 21. The blade unit 21 is configured to weed, and the blade motor 20 is configured to drive the blade unit 21 to weed. Further, the blade motor 20 is coupled to the CPU 5 and the blade unit 21. In such a manner, the CPU 5 is able to control the blade unit 21 to activate or to shut down depending on practical emergencies.

In the present embodiment, the wheel module 3 can include a wheel control unit 30, a wheel rotating motor 31, a rotary speed sensor 32, a front wheel mount 33 and a rear wheel mount 34. The wheel rotating motor 31 is coupled to the rear wheel mount 34 and configured to drive the mower body 1 to move forwards or backwards. The rotary speed sensor 32 is disposed near the rear wheel mount 34 and configured to detect a rotating speed of the rear wheel mount 34. The front wheel mount 33 is mounted on the mower body 1 and configured to change moving directions of the mower body 1 of the unmanned lawnmower 1000. The wheel control unit 30 is coupled to the CPU 5, the wheel rotating motor 31 and the rotary speed sensor 32. Practically, the wheel control unit 30 can be a circuitry on a main board of the unmanned lawn mower 1000. In such a manner, the CPU 5 is able to control the movement of the mower body 1 of the unmanned lawn mower 1000 through the wheel control unit 30, the wheel rotating motor 31, the rotary speed sensor 32, the front wheel mount 33 and the rear wheel mount 34.

As shown in FIG. 1, FIG. 5 and FIG. 6, the unmanned lawn mower 1000 can further include a blade shutdown module B, a battery module C, a power distribution module D and a lighting module E. The battery module C is functioned as a power supply of the unmanned lawn mower 1000. The power distribution module D is coupled to the battery module C and the CPU 5 and configured to distribute the power supplied by the battery module C to other modules of the unmanned lawn mower 1000, such as the cutting module 2, the wheel module 3, the camera module 4 and so on. The lighting module E is coupled to the CPU 5 and configured to provide a light source for the camera module 4 in a dusky light.

The blade shutdown module B is coupled to the CPU 5 and configured for tilt and lift sensing. For example, when the mower body 1 is lifted or tilted by an external force as the unmanned lawn mower 1000 is working and the cutting module 2 is activated, the blade shutdown module B is able to sense the attitude of the mower body 1 and sends an attitude warning signal to the CPU 5. The CPU 5 shuts down the cutting module 2 when receiving the attitude warning signal sent by the blade shutdown module B for the safety sake.

As shown in FIG. 1, FIG. 5 and FIG. 6, the unmanned lawn mower 1000 can further include a remote device communication module 7, a wireless signal based positioning module 8, a dead reckoning module 9 and a proximity sensor module A. The remote device communication module 7 is coupled to the CPU 5 and configured to establish connection with a handheld electronic device 6. In the present embodiment, the handheld electronic device 6 is illustrative of a smart phone, but the present invention is not limited to. For example, the handheld electronic device 6 can be a tablet or wristband and so on. The wireless signal based positioning module 8 is coupled to the CPU 5 and configured to position the mower body 1 by establishing connection with at least one wireless positioning terminal (not shown in figures).

In the present embodiment, the wireless signal based positioning module 8 can include at least one of a GPS module 80, a WiFi signal receiving module 81 and a Bluetooth signal receiving module 82. The GPS module 80 is configured to receive signals from satellites, so that the wireless signal based positioning module 8 could position the mower body 1 outdoors. The WiFi signal receiving module 81 is configured to establish connection with WiFi hotspots, i.e., the at least one wireless positioning terminal is WiFi hotspots, so that the wireless signal based positioning module 8 could position the mower body 1 indoors. The Bluetooth signal receiving module 82 is configured to establish connection with electronic devices with Bluetooth access, i.e., the at least one wireless positioning terminal is the electronic devices with Bluetooth access, so that the wireless signal based positioning module 8 could position the mower body 1 indoors.

The dead reckoning module 9 is coupled to the CPU 5 and configured to position the mower body 1. In the present embodiment, the dead reckoning module 9 can include a gyroscope 90 and/or an accelerometer 91. The gyroscope 90 is able to detect an orientation of the mower body 1 during a movement of the mower body 1, and the accelerometer 91 is able to detect a current speed of the mower body 1. A combination of the gyroscope 90 and the accelerometer 91 is able to position the mower body 1 without satellite signals, WiFi signals or Bluetooth signals.

The proximity sensor module A is coupled to the CPU 5 and configured to detect an object, e.g., an obstacle, a dog, a baby and so on, around the mower body 1. The proximity sensor module A generates a proximity warning signal when the object is within a predetermined range relative to the mower body 1, wherein the predetermined range depends on categories of the proximity sensor module A. In the present embodiment, the proximity sensor module A can be one or more selected from a sonar sensor module, an infrared sensor module, a light detection and ranging (LiDAR) module, a radar module.

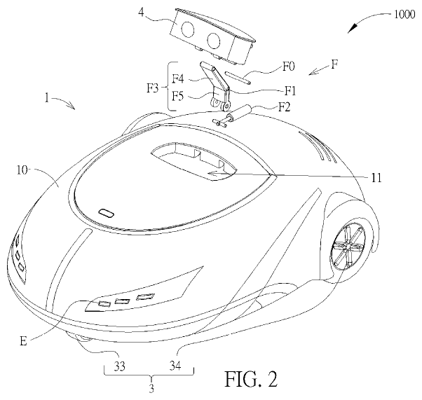

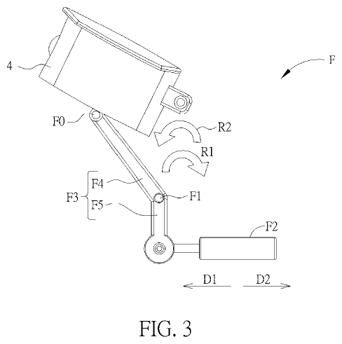

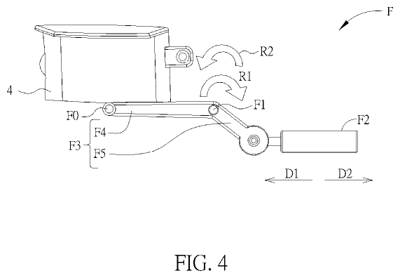

Referring to FIG. 2, FIG. 3 and FIG. 4, the unmanned lawn mower 1000 further includes a driving mechanism F, and the mower body 1 has a casing 10 whereon a recess 11 is formed. The driving mechanism F is mounted in the recess 11 and includes a first shaft F0, a second shaft F1, an activating member F2 and a lever member F3. The lever member F3 has a first lever part F4 and a second lever part F5 connected to the first lever part F4. The second shaft F1 is disposed through a conjunction where the first lever part F4 and the second lever part F5 are connected and configured to pivot the lever member F3 to the casing 10. An end opposite to the conjunction of the first lever part F4 is pivoted to the camera module 4 through the first shaft F0. An end opposite to the conjunction of the second lever part F5 is pivoted to the activating member F2 so that the activating member F2 could push the end of the second lever part F5 in a first driving direction D1 or to pull the end of the second lever part F5 in a second driving direction D2.

When the activating member F2 pushes the end of the second lever part F5 in the first driving direction D1, the lever member F3 pivots about the second shaft F1 to rotate relative to the casing 10 in a first rotating direction R1, leading to that the camera module 4 is lifted from a retracted position shown in FIG. 4 to an expanded position shown in FIG. 3. In such a manner, the camera module 4 is expanded to capture the images, as shown in FIG. 1. On the other hand, when the activating member F2 pulls the end of the second lever part F5 in the second driving direction D2, the lever member F3 pivots about the second shaft F1 to rotate relative to the casing 10 in a second rotating direction R2, leading to that the camera module 4 is retracted from the expanded position shown in FIG. 3 to the retracted position shown in FIG. 4. In such a manner, the camera module 4 is retracted for a containing and protection purpose.

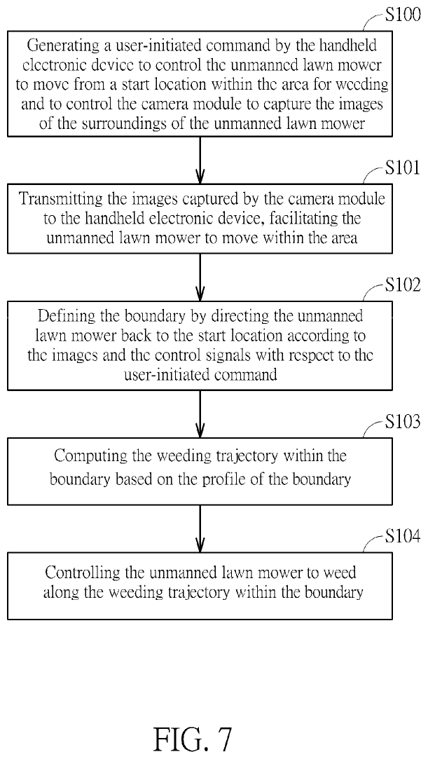

Referring to FIG. 7, a method for defining a boundary for the unmanned lawn mower 1000 to weed according to the embodiment of the present invention includes steps of:
Step S100: Generating a user-initiated command by the handheld electronic device 6 to control the unmanned lawn mower 1000 to move from a start location within the area for weeding and to control the camera module 4 to capture the images of the surroundings of the unmanned lawn mower 1000;
Step S101: Transmitting the images captured by the camera module 4 to the handheld electronic device 6, facilitating the unmanned lawn mower 1000 to move within the area;
Step S102: Defining the boundary by directing the unmanned lawn mower 1000 back to the start location according to the images and the control signals with respect to the user-initiated command;
Step S103: Computing the weeding trajectory within the boundary based on the profile of the boundary; and
Step S104: Controlling the unmanned lawn mower 1000 to weed along the weeding trajectory within the boundary.

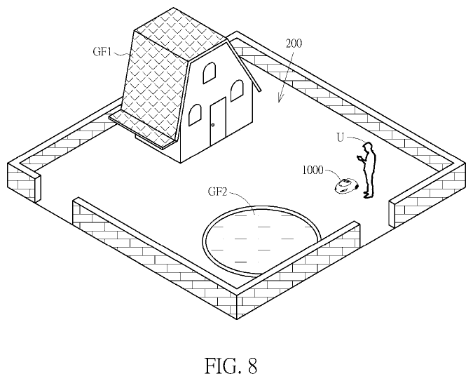

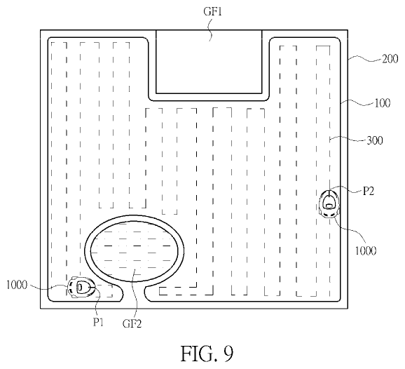

Referring FIG. 6 to FIG. 11, a user U utilizes the unmanned lawn mower 1000 to weed a yard of a house, and the yard has an area 200 with grass for weeding, as shown in FIG. 8. At first, the user U utilizes the handheld electronic device 6 to generate a user-initiated command to control the unmanned lawn mower 1000 to move from a start location (i.e., a first position P1 shown in FIG. 9) within the area 200 for weeding and to control the camera module 4 to capture the images of the surroundings of the unmanned lawn mower 1000 (step 100). Meanwhile, the CPU 5 controls the remote device communication module 7 to transmit the images captured by the camera module 4 to the handheld electronic device 6, facilitating the unmanned lawn mower 1000 to move within the area (step 101). In other words, when the unmanned lawnmower 1000 is controlled to proceed through the handheld electronic device 6, the CPU 5 is able to simultaneously control the camera module 4 to capture the images of the surroundings around the mower body 1 and control the remote device communication module 7 to transmit the images back to the handheld electronic device 6.

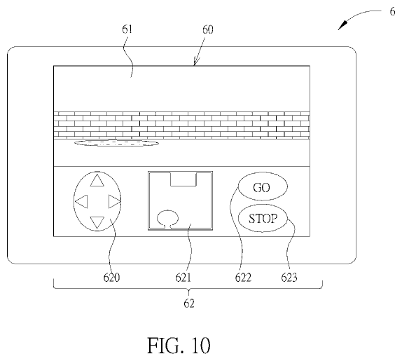

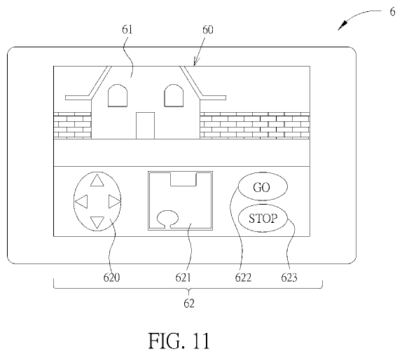

For example, when the unmanned lawn mower 1000 is in the start location (i.e., the first position P1 shown in FIG. 9), the remote device communication module 7 sends the images captured by the camera module 4 back to the handheld electronic device 6, so that a real time display section 61 of a user interface 60 of the handheld electronic device 6 (as shown in FIG. 10) shows a content related to the images captured by the camera module 4 in the start location (shown in FIG. 10). When the unmanned lawnmower 1000 is in the second position P2 shown in FIG. 9, the remote device communication module 7 sends the images captured by the camera module 4 back to the handheld electronic device 6, so that the real time display section 61 of the user interface 60 of the handheld electronic device 6 (as shown in FIG. 10) shows a content related to the images captured by the camera module 4 in the second position (shown in FIG. 11).

Besides the real time display section 61, the user interface 60 of the handheld electronic device 6 further has a control section 62 including a direction button section 620, a mapping section 621, a go button section 622 and a stop button section 623. The direction button section 620, the go button section 622 and the stop button section 623 of the control section 62 are configured to generate the user-initiated commands, so that the user U could operably generate the user-initiated commands for controlling the unmanned lawn mower 1000 in cooperation with the images sent by the remote device communication module 7 of the unmanned lawn mower 1000.

Afterwards, the CPU 5 is able to define the boundary 100 by directing the unmanned lawn mower 1000 back to the start location according to the images and the control signals with respect to the user-initiated command (step 102). In other words, after completion of directing the unmanned lawn mower 1000 from the start location (i.e., the first position P1 shown in FIG. 9) back to the start location through the user-initiated command sent by the handheld electronic device 6, the close-loop boundary 100 is defined, i.e., the boundary 100 within the area 200 for weeding is defined by the control signals sent by the handheld electronic device 6 cooperatively with the images captured by the camera module 4, and the unmanned lawn mower 1000 weeds within the boundary 100.

It should be noticed that during the movement of the unmanned lawn mower 1000 from the start location back to the start location, the CPU defines a plurality of image characteristics on the boundary 100 according to the images captured by the camera module 4. For example, when the camera module 4 captures an image of a first geographic feature GF1 shown in FIG. 9, the CPU deems the first geographic feature GF1 as one of the image characteristics on the boundary 100, wherein the first geographic feature GF1 is illustrative of a pool, but the present invention is not limited thereto. Furthermore, the user U is able to see the one of the image characteristics and control the unmanned lawn mower 1000 to detour. Namely, when the unmanned lawnmower 1000 for a second geographic feature GF2 in FIG. 9, which is deemed as the house, same procedure is implemented and descriptions are omitted herein for simplicity.

In the present embodiment, the camera module 4 can be a stereo camera, leading to that each of the image characteristics includes a depth message, i.e., a distance between the mower body 1 and the corresponding geographic feature is included in the image characteristic through image processing by a binocular field of views generated by the stereo camera. The boundary 100 can be generated by the depth message of the surroundings and be showed as the mapping section 621. Preferably, distance information detected by the proximity sensor module A can be referenced by the CPU 5 when generating the mapping section 621. The category of the camera module 4 is not limited to that illustrated in the present embodiment. For example, the camera module 4 can be a depth camera, a monocular camera and so on, and it depends on practical demands.

When the boundary 100 is defined, the CPU 5 computes the weeding trajectory 300 within the boundary 100 based on the profile of the boundary 100 (Step 103). Practically, the CPU computes the weeding trajectory 300 through several algorithms, such as an artificial potential field method, a grid method, a fuzzy control algorithm, a neural network path planning method and so on. Afterwards, the CPU 5 controls the unmanned lawn mower 1000 to weed along the weeding trajectory 300 within the boundary 200.

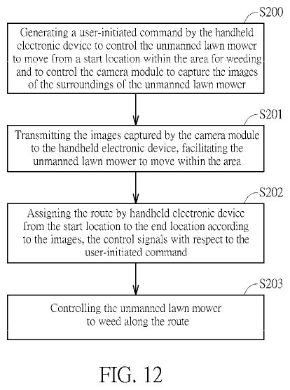

Referring to FIG. 12, a method for defining a route for the unmanned lawn mower 1000 to weed according to another embodiment of the present invention includes steps of:
Step S200: Generating a user-initiated command by the handheld electronic device 6 to control the unmanned lawn mower 1000 to move from a start location within the area for weeding and to control the camera module 4 to capture the images of the surroundings of the unmanned lawn mower 1000;
Step S201: Transmitting the images captured by the camera module 4 to the handheld electronic device 6, facilitating the unmanned lawn mower 1000 to move within the area;
Step S202: Assigning the route by handheld electronic device 6 from the start location to the end location according to the images, the control signals with respect to the user-initiated command; and
Step S203: Controlling the unmanned lawn mower 1000 to weed along the route.

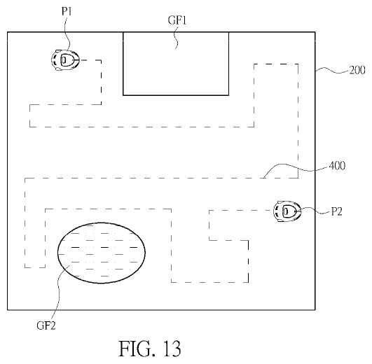

The major difference between the method of the present embodiment and that of the aforesaid embodiment is that the route 400 within the area 200 for weeding is defined by the control signals sent by the handheld electronic device 6 cooperatively with the images captured by the camera module 4, and the unmanned lawn mower 1000 weeds along the route 400. In other words, the route 400 for weeding is assigned by the handheld electronic device 6 from the start location (i.e., a first position P1 shown in FIG. 13) to the end location (i.e., a second position P2 shown in FIG. 13) according to the images. More specifically, the route 400 is generated from the control signals with respect to the user-initiated command assigned by the handheld electronic device 6. The information contained in the each point of the route 400 includes the positioning information provided by the wireless signal based positioning module 8, the distance information from the surroundings provided by the proximity sensor module A, and the depth information provided by the camera module 4. The generated route 400 will be stored in a storage unit G and the unmanned lawn mower 1000 will recall the route 400 every time when weeding.

Since the unmanned lawn mower 1000 is able to be equipped with the wireless signal based positioning module 8 and/or the dead reckoning module 9, except for the control signals sent by the handheld electronic device and the images captured by the camera module, the boundary 100 or the route 400 is further defined by wireless positioning signals transmitted from the at least one positioning terminal and/or further defined by the dead reckoning module 9, and the unmanned lawn mower 100 weeds within the boundary 100 or along the route 400.

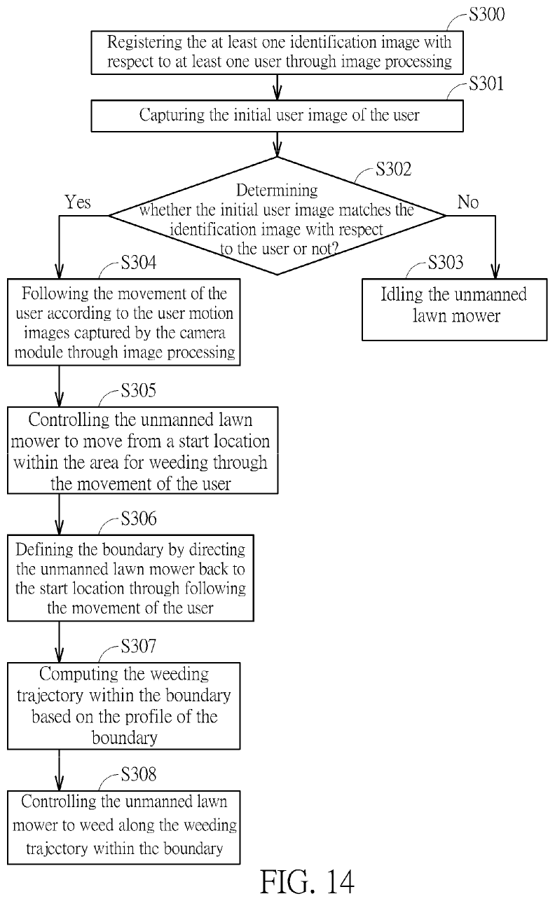

Referring to FIG. 6 and FIG. 14, the unmanned lawn mower 1000 can further include the storage unit G coupled to the CPU 5. The storage unit G is configured to store at least one identification image registered, but the present invention is not limited thereto. For example, the storage unit G is further able to store the aforesaid information, including one or more selected from the boundary 100, the images captured by the camera module 4, positioning information captured by the wireless signal based positioning module 8, distance information captured by the proximity sensor module A. A method for defining the boundary 100 for the unmanned lawn mower 1000 to weed by following a movement of the user U according to another embodiment of the present invention includes steps of:
Step S300: Registering the at least one identification image with respect to at least one user through image processing;
Step S301: Capturing the initial user image of the user;
Step S302: Determining whether the initial image matches the identification image with respect to the user? If yes, go to step S303; if no, go to step S304;
Step S303: Idling the unmanned lawn mower;
Step S304: Following the movement of the user according to the user motion images captured by the camera module through image processing;
Step S305: Controlling the unmanned lawn mower to move from a start location within the area for weeding through the movement of the user;
Step S306: Defining the boundary by directing the unmanned lawn mower back to the start location through following the movement of the user;
Step S307: Computing the weeding trajectory within the boundary based on the profile of the boundary; and
Step S308: Controlling the unmanned lawn mower to weed along the weeding trajectory within the boundary.

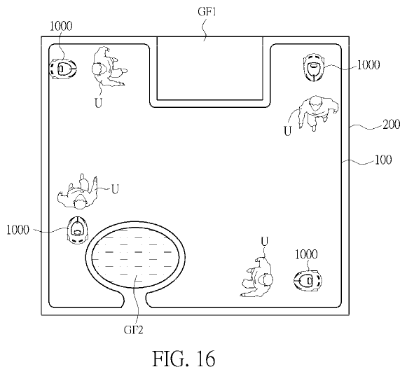

As shown in FIG. 6 and FIG. 14 to FIG. 16, another way to define a boundary or a route through the unmanned lawnmower 1000 of the present invention is to follow a user's movement around the boundary or along the route. The unmanned lawnmower 1000 of the present invention following the user's movement around the boundary is illustrative of an example herein. At first, the user U needs to register his/her identification image through image process (Step S300), i.e., the camera module 4 is utilized for capturing the identification image with respect to the user U, and the CPU 5 registers the identification image with the storage unit G storing the identification image. It should be noticed that operating procedure of registration of the identification image of the present invention is not limited thereto. For example, the unmanned lawn mower 1000 can further include an image control unit, e.g., a Graphics Processing Unit (GPU), for the operating procedure of registration of the identification image, and it depends on practical demands. In the present embodiment, the identification image includes message of a pose estimation (i.e., an identification image model with a skeleton), a color of clothes and so on.

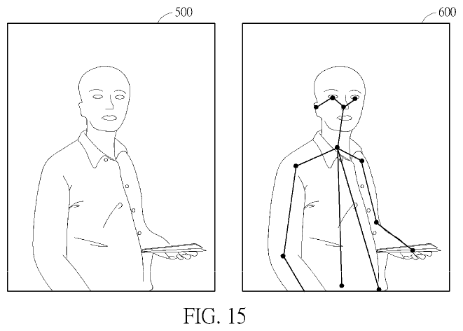

When the unmanned lawn mower 1000 is desired to weed, at first, an initial user image 500 of the user U, as shown in FIG. 15, is required to be captured by the camera module 4 of the unmanned lawn mower 1000 (Step S301). Meanwhile, the CPU 5 transfers the initial user image 500 into an initial image model 600, which includes message of a pose estimation (i.e., an identification image model with a skeleton), a color of clothes and so on. When the initial image model 600 with respect to the user U is established, the CPU 5 determines whether the initial user image 500 matches the identification image by checking the initial image model 600 with the message of the identification image (i.e., the pose estimation, the color of clothes and so on).

When the initial user image 500 does not match the identification image, the user U does not pass the check and the unmanned lawn mower 1000 idles (Step S303). When the initial user image 500 matches the identification image, the user U passes the check and the CPU 5 controls the mower body 1 to follow the movement of the user U according to the user motion image captured by the camera module 4 through image processing (Step S304), in order for the boundary or route definition. Steps S305 to S308 are similar to those in FIG. 7, and related descriptions are omitted herein for simplicity.

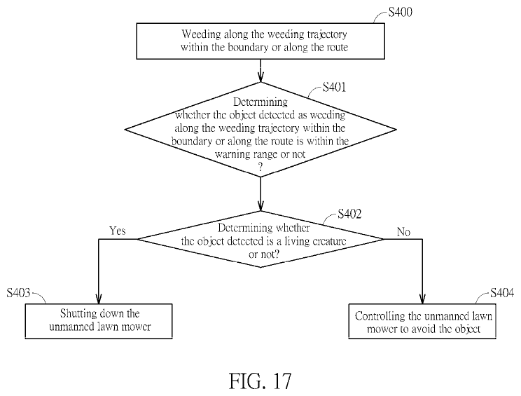

Referring to FIG. 17, a method for obstacle avoidance and shutdown for living creature includes steps of:
Step S400: weeding along the weeding trajectory within the boundary or along the route;
Step S401: Determining whether the object detected as weeding along the weeding trajectory within the boundary or along the route is within the warning range or not? If yes, perform step S402; if no, go back to step s400;
Step S402: Determining whether the object detected is a living creature or not? If yes, perform step S403; If no, perform step S404;
Step S403: Shutting down the unmanned lawn mower; and
Step S404: Controlling the unmanned lawn mower to avoid the object.

It should be noticed that certain emergency cases might occur during weeding process, and hence, there are procedures implemented for the certain emergency cases. when the unmanned lawn mower 1000 weeds along the weeding trajectory 300 within the boundary 100 or along the route 400, the proximity sensor module A detects objects on the weeding trajectory 300 or along the route 400 (Step S400). Herein, it is illustrative of an example that the unmanned lawn mower 1000 weeds along the weeding trajectory 300 and the camera module 4 is a stereo camera.

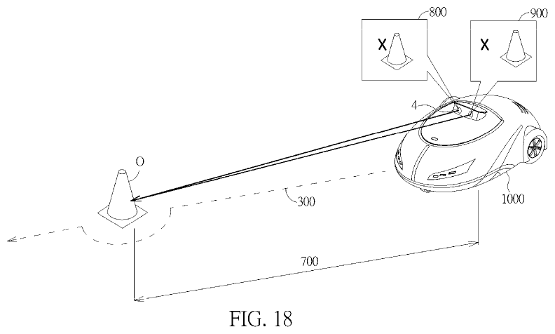

As shown in FIG. 17 to FIG. 19, when the unmanned lawn mower 1000 weeds along the weeding trajectory 300 and an object O is present on the weeding trajectory 300, the camera module 4 (i.e., the stereo camera) is able to capture an right image 800 and a left image 900 with respect to the object O, respectively. Practically, there is a disparity between the right image 800 and the left image 900, and the disparity can be used for computing a distance 700 between the object O and the unmanned lawn mower 1000. When the distance 700 between the object O and the unmanned lawn mower 1000 is computed, the CPU further determines whether the object O detected (or the distance 700) is within the warning range or not (step S401).

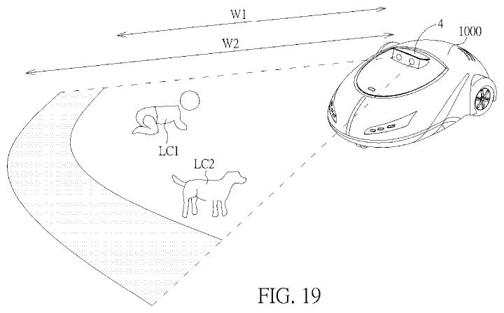

When the object O detected (or the distance 700) is not within the warning range, the unmanned lawn mower 1000 continues to weed along the weeding trajectory 300 (step S400). When the object O detected (or the distance 700) is within the warning range, the CPU 5 further determines whether the object O detected is a living creature or not (step S402). The identification of living creature can be implemented by comparing the object O with skeleton analysis diagrams stored in the storage unit G. When the object O detected is not a living creature, the CPU 5 controls the unmanned lawn mower 1000 to avoid the object O (step S403). When the object O detected is a living creature, e.g., living creatures LC1, LC2 are respectively illustrated as a baby and a pet in FIG. 19, the CPU 5 controls the unmanned lawn mower 1000 to shut down for the safety sake (step S402).

Compared to the prior art, the unmanned lawn mower of the present invention is equipped with the camera module to capture the image of the surroundings of the mower body, allowing the boundary or the route within the area for weeding to be defined by the images captured by the camera module through image processing. It not only leads to convenience of use for the unmanned lawn mower of the present invention, but also enables the unmanned lawn mower of the present invention to be more artificially intelligent.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An unmanned lawn mower with autonomous driving, comprising:
a mower body;
a cutting module mounted on the mower body and configured to weed;
a wheel module mounted on the mower body and configured to move the mower body;
a camera module mounted on the mower body and configured to capture images of surroundings of the mower body; and
a central processing unit (CPU) mounted in the mower body and coupled to the cutting module, the wheel module and the camera module;
wherein the central processing unit controls the cutting module and the wheel module to weed within an area according to the images captured by the camera module and control signals from a handheld electronic device, or the central processing unit controls the cutting module and the wheel module to weed within the area according to the images captured by the camera module.

2. The unmanned lawn mower of claim 1, wherein a boundary within the area for weeding is defined by the control signals sent by the handheld electronic device cooperatively with the images captured by the camera module, and the unmanned lawn mower weeds within the boundary.

3. The unmanned lawnmower of claim 2, wherein the CPU defines a plurality of image characteristics on the boundary according to the images captured by the camera module.

4. The unmanned lawn mower of claim 3, wherein the camera module is a stereo camera, and each of the image characteristics comprises a depth message.

5. The unmanned lawn mower of claim 2, wherein the CPU computes a weeding trajectory within the boundary based on a profile of the boundary.

6. The unmanned lawn mower of claim 1, wherein a route within the area for weeding is defined by the control signals sent by the handheld electronic device cooperatively with the images captured by the camera module, and the unmanned lawn mower weeds along the route.

7. The unmanned lawnmower of claim 6, wherein the CPU defines a plurality of image characteristics on the plurality of routes according to the images captured by the camera module.

8. The unmanned lawn mower of claim 7, wherein the camera module is a stereo camera, and each of the image characteristics comprises a depth message.

9. The unmanned lawn mower of claim 1, further comprising:
a wireless signal based positioning module coupled to the CPU and configured to position the mower body by establishing connection with at least one wireless positioning terminal, wherein a boundary or a route is defined by the control signals sent by the handheld electronic device, the images captured by the camera module and wireless positioning signals transmitted from the at least one positioning terminal, and the unmanned lawn mower weeds within the boundary or along the route.

10. The unmanned lawn mower of claim 9, further comprising:
a dead reckoning module coupled to the CPU and configured to position the mower body, wherein the boundary or the route is further defined by the dead reckoning module.

11. The unmanned lawn mower of claim 10, wherein the wireless signal based positioning module comprises at least one of a GPS module, a WiFi signal receiving module and a Bluetooth signal receiving module, and the dead reckoning module comprises a gyroscope and/or an accelerometer.

12. The unmanned lawn mower of claim 1, further comprising:
a proximity sensor module coupled to the CPU and configured to detect an object around the mower body, the proximity sensor module generating a proximity warning signal when the object is within a predetermined range relative to the mower body.

13. The unmanned lawn mower of claim 1, further comprising:
a remote device communication module coupled to the CPU and configured to establish connection with the handheld electronic device;
wherein the handheld electronic device operably sends the control signals to the remote device communication module, and the CPU controls:
the wheel module to move based on the control signals; and
the camera module to capture the images when the mower body is moved;
wherein the CPU controls the remote device communication module to transmit the images to the handheld electronic device.

14. The unmanned lawn mower of claim 1, further comprising:
a storage unit coupled to the CPU and configured to store at least one identification image registered;
wherein the CPU determines an initial user image of a user captured by the camera module matches the at least one identification image registered, and the CPU controls the wheel module to follow a movement of the user according to user motion images captured by the camera module when the initial user image of the user matches the at least one identification image registered, so as to define a boundary within the area for weeding, and the unmanned lawn mower weeds within the boundary.

15. The unmanned lawn mower of claim 14, wherein the CPU defines a plurality of image characteristics on the boundary according to the images captured by the camera module.

16. The unmanned lawn mower of claim 15, wherein the camera module is a stereo camera, and each of the image characteristics comprises a depth message.

17. The unmanned lawn mower of claim 14, wherein the CPU computes a weeding trajectory within the boundary based on a profile of the boundary.
